(19) United States
(12) Patent Application Publication
(10) Pub. No.: US 2012/0086868 A1
(43) Pub. Date: Apr. 12, 2012

(54) APPARATUS AND METHOD FOR TAMPER LOCKING ELECTRONICS

(75) Inventor: Norifumi Takaya, San Diego, CA (US)

(73) Assignee: Sony Corporation, Tokyo (JP)

(21) Appl. No.: 12/900,883

(22) Filed: Oct. 8, 2010

(51) Int. Cl. H04N 5/44

(52) U.S. Cl. 348/734; 348/E05.096

(57) ABSTRACT

A remote control designed to operate an electronic device comprising: a housing, a plurality of buttons arranged on the housing, and a single button is designed to lock the plurality of buttons on the remote control.

### FIELD

The present patent document relates to apparatus and methods for locking electronics against accidental or unwanted tampering.

### BACKGROUND

Many electronic devices sold today come with a remote control. The remote control that accompanies an electronic device allows users to operate the device from some distance away. For example, a remote control allows a television viewer to change the channel without getting off the couch and walking over to the television. Typically, remote controls can control many of the functions of the electronic device, including but not limited to powering the device on and off, selecting specific functions of the electronic device, and controlling the volume.

While using a remote control can make operating an electronic device more convenient, remote controls may also pose a hindrance. The buttons of the remote control may get accidentally pushed or pressed and consequently, the electronic device may perform an unwanted function. The buttons may be accidentally or unexpectedly pressed by small children, animals, other users, or the owners themselves. In addition, remote controls may fall into unwanted areas such as between the cushions of a couch. Remote controls may get accidentally stepped on, which could cause the remote control to accidentally activate the electronic device. Furthermore, remote controls may be accidentally bumped or dropped which may also cause the unwanted operation of the electronic device.

If the buttons of the remote control are accidentally engaged, the electronic device may perform an unwanted function. For example, the electronic device may accidentally turn off in the middle of an important portion of the devices operation. In the case of a television, a television may turn off right before the winning goal is scored or the game winning shot is made. Other examples of unwanted operations include unexpectedly changing the channel or muting the volume at an inopportune time.

Furthermore, young children are often very inquisitive about remote controls and want to play with the remote control. If the little kid gets to play with the remote control, the child will almost certainly begin pressing buttons and thus cause the electronic device to perform unwanted functions. If the adult prevents the child from playing with the remote control the child may become upset and irritated.

In addition to the unwanted or accidental operation that may be caused by the buttons on the remote control, similar problems exist with the panel buttons of electronic devices. Front panel buttons are often within the reach of small children and may be bumped or pushed. Similar to the remote, small children are often fascinated with buttons and preventing the small child from pressing the buttons could irritate or upset the child. Furthermore, as explained above, pushing or bumping the buttons on the front panel could cause unwanted operation at inopportune times. Animals may also accidentally brush against or bump the buttons on the front panel causing unwanted activation or operation of the device.

Unwanted or accidental operation of an electronic device may also have detrimental side effects on the life of the electronic device. Repetitive operation of some electronic device functions could cause damage to the electronic device. For example, turning the device on and off in successive fashion may cause electric surges in the device that are detrimental to the life of the device. By reducing the unwanted or accidental functions of the device, the life of the device may be prolonged.

### SUMMARY OF THE EMBODIMENTS

In view of the foregoing, an object according to one aspect of the present patent document is to provide improved apparatus and methods for providing unwanted or undesired control of electronic devices. Preferably the apparatus and methods address, or at least ameliorate one or more of the problems described above. To this end, a remote control designed to operate an electronic device is provided. In one embodiment the remote control comprises: a housing; and a plurality of buttons arranged on the housing wherein a single button is designed to lock the plurality of buttons on the remote control.

In at least one embodiment, a single button is designed to lock the plurality of buttons on the remote control with a single push. In certain embodiments, a key combination is required to confirm the unlocking of the remote control and/or electronic device.

The electronic device may be any number of devices including but not limited to a, display device, Blu-ray® player, DVD player, personal computer (PC), Digital Video Recorder (DVR) or some other electronic device in which tamper prevention is required. In at least one embodiment, the electronic device is a television.

In yet another embodiment, the single button designed to lock and/or unlock the plurality of buttons may be brightly colored to allow the button to stand out.

In another embodiment, the single button designed to lock and/or unlock the plurality of buttons is designed to unlock the plurality of buttons by simultaneous pushing the single button with at least one other button. In another embodiment, instead of simultaneously pushing another button, a sequence is subsequently entered after the single lock button is pushed.

In yet another embodiment, the firmware of the remote control is designed to prevent a transmission of a signal by the remote control when the remote control is locked. In yet another embodiment, the firmware of the electronic device is designed to ignore a signal from the remote control when the remote control is locked.

In another embodiment, a system for preventing unwanted control of an electronic device is provided; the system comprises: a remote control configured to operate a television, the remote control comprising, a housing; a plurality of buttons arranged on the housing; and a single button designed to lock the plurality of buttons on the remote control.

In one embodiment of the system for preventing unwanted control of an electronic device, the system further comprises a television. The television further comprises: a television housing; a plurality of television buttons arranged on the television housing; and a single television button designed to lock the plurality of television buttons.

In another embodiment, the single button designed to lock the plurality of buttons on the remote control is also designed to lock the plurality of television buttons. In yet another embodiment, the single television button designed to lock the plurality of television buttons is also designed to lock the plurality of buttons on the remote control.

In another embodiment, the television is designed to bring up an on-screen-display for a password when the single button on the remote control is pressed to unlock the remote control or the television.

In yet another embodiment, a method of preventing unwanted control of a television is provided, the method comprises the steps of: receiving a key combination designed to confirm an unlock signal; receiving a first signal from a single button on a remote control or the television designed to enable a lock state; and disabling the functionality of a plurality of buttons on the remote control and the television.

In another embodiment the method further comprises the step of receiving a second signal from the single button on the remote control or the television designed to disable the lock state.

In another embodiment, the method further comprises the steps of receiving an unlock key combination; and comparing the unlock key combination with the key combination designed to confirm an unlock signal. If the key combinations match, the functionality of the plurality of buttons on the remote control and the television are enabled.

Different key combinations may be used to confirm the unlock signal. In one embodiment, the unlock key combination includes depressing the single button on the remote and simultaneously depressing at least one of the plurality of buttons on the remote. In another embodiment, the unlock key combination includes depressing a sequence of the plurality of buttons on the remote.

In yet another embodiment, the method further comprises the step of displaying an on-screen-display on the television requesting the unlock key combination after the step of receiving a second signal from the single button on the remote control or the television designed to disable the lock state.

As described more fully below, the apparatus and methods of the embodiments permit the locking of remote controls and/or electronic devices to prevent accidental or unexpected functioning. Further aspects, objects, desirable features, and advantages of the apparatus and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed embodiments.

### BRIEF DESCRIPTION OF THE DRAWINGS

FIG. 1 illustrates a system with an electronic device including a lock to prevent accidental tampering.

FIG. 2A illustrates an on screen display of an electronic device including a lock to prevent accidental tampering.

FIG. 2B illustrates an on screen display for entering a lock code for an electronic device including a lock to prevent accidental tampering.

FIG. 3A illustrates an on screen display for entering a lock code to lock an electronic device.

FIG. 3B illustrates an on screen display for entering a lock code to unlock an electronic device.

FIG. 4 illustrates a method of locking or unlocking an electronic device and/or remote control.

### DETAILED DESCRIPTION OF THE EMBODIMENTS

Consistent with its ordinary meaning, the term “lock” or “locked” is used herein to refer to preventing the normal operation of the buttons located on a device and/or the corresponding remote control of the device. “Tamper lock” or “lock out” may also be used in the place of “lock.” When an electronic device is “locked” some or all of the buttons on the remote control and/or electronic device no longer operate normally. For example, the buttons may be pushed, pressed or activated with no apparent result. It is not important how the lock is implemented only that some portion of the buttons may be pushed without effecting their normal result.

Consistent with its ordinary meaning, the term “button” is used herein to refer to any small knob or disk pressed to activate an electronic circuit or otherwise operate an electronic device, machine, toy or other device. Button also includes areas of a touch screen or other input device design to operate as a button. Buttons may be any shape or design and are not limited to disk or other round shapes. Furthermore, the term button as used herein may also include switches or other devices designed to provide input to an electronic device.

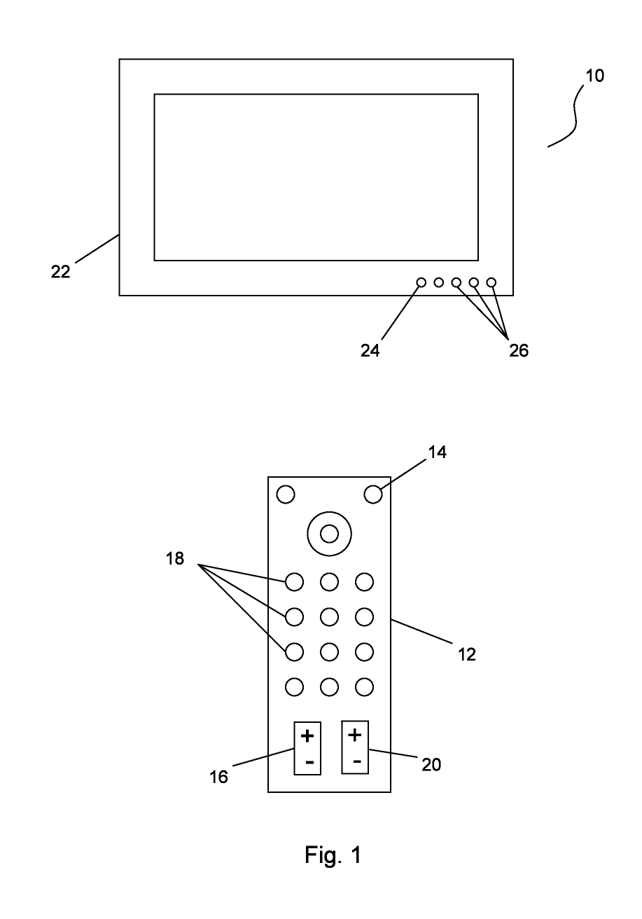

FIG. 1 illustrates a system 10 with an electronic device 22, a remote control 12, and corresponding lock buttons 14 and 24 designed to prevent accidental tampering. The system of claim 10 includes an electronic device 22 and a remote control 12. While the electronic device 22 of the system 10 is displayed as a display device such as a television, the embodiments of the present patent document include any electronic device and are not limited to a television. For example, the electronic device 22 may be a Blu-ray® player, DVD player, stereo receiver, monitor, personal computer (PC), Digital Video Recorder (DVR) or other electronic device. Furthermore, the electronic device 22 may be designed for home or commercial use.

The embodiment illustrated in FIG. 1 includes a remote control 12. The remote control 12 is designed to allow a user to operate the electronic device 22 from some distance away. For example, in the embodiment of FIG. 1, a user may operate the television while sitting on a couch. Typically, remote controls 12 use infrared technology to communicate with the electronic device 22 and allow a user to control the electronic device 22 from a distance. However, remote controls 12 may use other communication technologies to operate the electronic device 22 including IEEE 802.11 (WiFi), Bluetooth®, or any other communication technology that allows electronic devices to communicate at a distance.

The remote control 12 may have a number of buttons 16, 18, and 20. The buttons may be of various types including buttons that are assigned to numbers or buttons that increase or decrease a variable such as the volume button 16 or the channel button 20. The remote control 12 also includes a single lock button 14 designed to lock the buttons on the remote control 12 and/or the electronic device 22.

As shown in FIG. 1, the electronic device 22 may also have a single lock button 24 along with a number of other buttons 26. The buttons 26 and the lock button 22 are shown on the front panel of electronic device 22, however, the buttons may be located anywhere on the electronic device 22 including but not limited to the side, behind a panel, or any other location.

In one embodiment, the lock button 14 and/or 24 may be brightly color or backlit to make the button easily seen or detected. Preferably, the lock button 14 and/or 24 is brightly colored and has “LOCK” written across it in an easy to read lettering. Drawing attention to the lock button 14 and/or 24 suggests to the user that it should be pressed first and helps avoid confusion when the other buttons do not appear to be operating correctly, as is the case when the lock is enabled. However, in other embodiments, the lock buttons 14 and/or 24 are not brightly colored and may match the rest of the buttons on the remote control 12 or the electronic device 22.

Providing a single lock button 14 and/or 24 on the remote control 12 or the electronic device 22 to initiate locking allows the user to easily lock the electronic device 22 and/or the remote control 12 without navigating through a number of menu screens. When it is desired to lock the remote control 12 or the electronic device 22, only a single button push is required to initiate the process. In the preferred embodiment, a single push of the lock button 14 or 24 locks all the other buttons on the remote control 14 and the electronic device 22.

Although the system 10 in FIG. 1 is shown with both a electronic device 22 and a remote control 12, the system 10 is not required to include a remote control 12 and may only include the electronic device 12 with the lock button 24. In addition, the system 10 may not include the electronic device 22 and may just include the remote control 12 with the lock button 14. For example, a remote control 12 including a lock button 14 that may be subsequently programmed to work with an electronic device 22 is one example of an embodiment of the system 10 without an electronic device 22. Preferably, the system 10 includes both the electronic device 22 and the remote control 12 designed to work with and operate the electronic device 22.

In embodiments that include both a remote control 12 and an electronic device 22, preferably both the remote control 12 and the electronic device 22 have a lock button 14 and 24 respectively. However, both are not required to have a lock button 14 and 24. In one embodiment, only the remote control 12 includes a lock button 14. In another embodiment, only the electronic device 22 has a lock button 24.

When the lock button 14 on the remote control 12 is activated or pressed, preferably the buttons on both the remote control 12 and the electronic device 22 are locked. Similarly, when the lock button on the electronic device 22 is pressed, preferably the buttons on both the remote control 12 and the electronic device 22 are locked. However, in other embodiments the locking function may operate in other ways. For example, pressing the lock button 14 on the remote control 12 may lock just the remote control 12 or just the electronic device 22. In addition, pressing the lock button 24 on the electronic device 22, may lock just the electronic device 22 or just the remote control 12.

When the remote control 12 or the electronic device 22 is locked, preferably all of the buttons except for the single lock button 14 and/or 24, which may be used to unlock, are disabled or not functioning. However, not all the buttons need to be disabled. In one embodiment, pressing the lock button 14 or 24 may only disable the button that controls power to the device. In another embodiment, pressing the lock button 14 or 24 disables all the buttons except for the button(s) that control the volume of the electronic device 22. In certain embodiments, even the lock button 14 and/or 24 itself may be disabled. Numerous other combinations of enabled and disabled buttons are possible in the embodiments of the present patent document.

The system 10 may implement the locking feature in a number of ways. For example, the remote control 12 may include firmware that disables transmissions when the remote control 12 is in a locked state. Consequently, when the remote control 12 is in a locked state and the user accidentally presses buttons on the remote control, no signal is dispatched from the remote control 12 and the electronic device 22 does not perform the unwanted or unexpected function.

In yet another embodiment, the electronic device 22 may have firmware that is programmed to ignore a signal received from the remote control 12 and/or a button on the electronic device 22 when the remote control 12 or the electronic device 22 or both are in a locked state. Other implementations of locking the electronic device 22 and/or the remote control 12 are possible, including combinations of firmware on both the remote control 12 and the electronic device 22 that implement the locking feature, without departing from the scope of the embodiments of the present patent document.

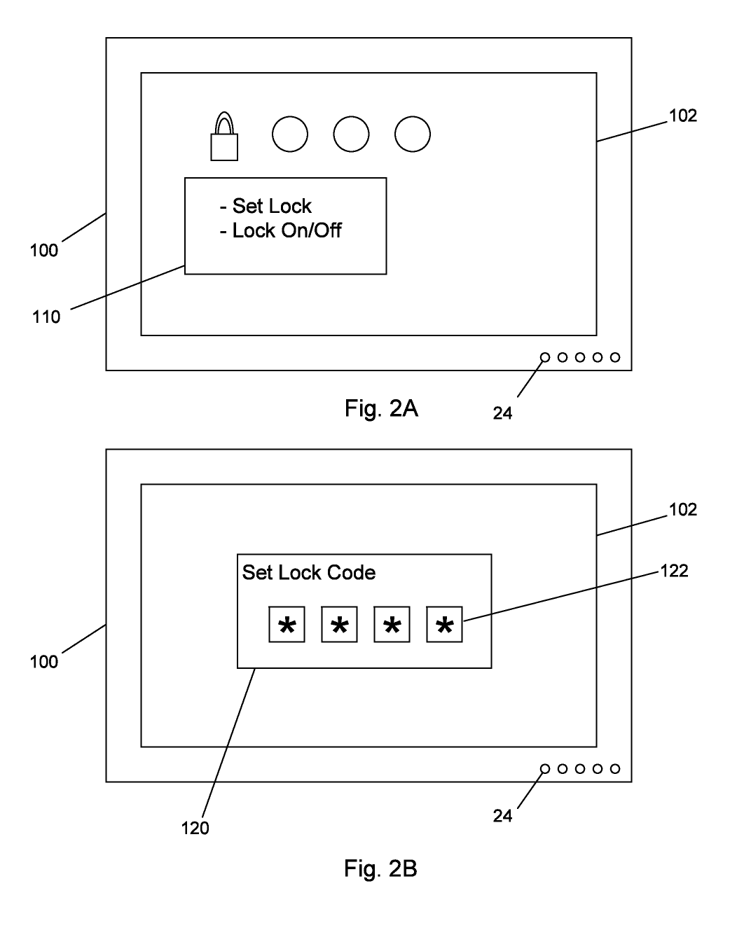

FIG. 2A illustrates an on screen display of an electronic device including a lock to prevent accidental tampering. In FIG. 2A, the electronic device 100 includes lock button 24. The electronic device 100 is depicted in FIG. 2A as a television having display 102. The firmware of the electronic device 100 may contain software configured to display an on-screen-display (OSD) 110, which allows the user to perform tasks related to the locking feature. For example, in at least one embodiment, the OSD allows the user to set the lock code and turn the lock on and off.

FIG. 2B illustrates the OSD for setting the lock code 120. As just one example, a four character/digit lock code may be entered to prevent accidental locking or unlocking of the electronic device 100. As shown in FIG. 2B, the characters may be replaced with an asterisk as they are entered to prevent visual display of the lock code to those in viewing range of the display 102.

While FIGS. 2A and 2B show one embodiment contemplated by the present patent document that includes OSD's to setup the tamper lock and allow a user to enter a password, OSD's are not required in other embodiments. For example, pressing the lock button 14 or 24 alone, without entering a password, may lock and/or unlock the electronic device 100 and/or remote control 12. In another embodiment, the lock button 14 and/or 24 may be used in combination with another user selected button to lock the device. For example, the lock button 14 and/or 24 may be held down in combination with one of the other buttons 16, 18, 20 or 26. The user may press both the lock button 14 and/or 24 and another button simultaneously to enable or disable the lock. Pressing an additional button simultaneously with the lock button 14 or 24 to enable or disable the lock makes it unlikely that the locking feature is accidentally activated or deactivated. Depressing both the lock button and another button simultaneously due to an accident would be a rare occurrence.

As yet another example, the lock button 14 or 24 may be pressed followed by a key sequence to lock or unlock the electronic device 22 and/or remote control 12. For example, the user may be required to press the lock button 14 and/or 24 followed immediately by some combination of other keys to change the lock state of the remote control 12 and/or electronic device 22. The key sequence may or may not include pressing the lock button 14 and/or 24 again. In embodiments including OSD's, an OSD may be displayed to prompt the user to enter the key sequence after the lock or unlock state change is initiated by pressing the lock button 14 and/or 24.

As mentioned above, OSD's are not required and the user may set up a password, key combination, or a key to simultaneous press in conjunction with the lock button 14 and/or 24 using other methods. For example, the lock button may be held down for a period of time to indicate a setup operation. In an embodiment with backlit buttons, the buttons may begin to blink to indicate to the user that a setup operation may be performed. The user may then enter the key combination or select the simultaneous key to act as a password for enabling or disabling the locking feature. In one embodiment, the lock button 14 and/or 24 may be depressed for a second time to indicate that the key combination constituting the password has been complete. The remote control 12 and electronic device 22 will then be setup to require the particular key combination entered by the user to follow the depression of the lock button 14 and/or 24 to lock and/or unlock the remote control 12 and/or electronic device 22.

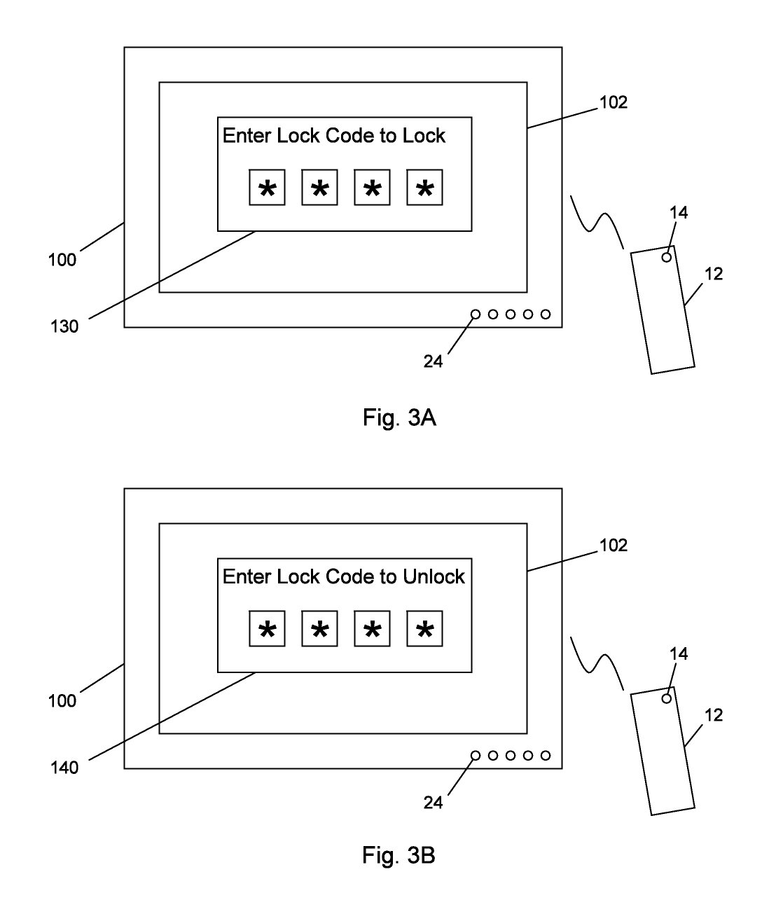

FIG. 3A illustrates an on screen display for entering a lock code to lock an electronic device 100. In an embodiment where the electronic device includes a display 102, it is preferable to use an OSD to provide feedback to a user when entering a key combination. In embodiments requiring a password or some key combination, once the password or key combination is setup, the user will be required to enter the key combination after depressing the lock button to enable and/or disable the lock. For example, in the embodiment shown in FIG. 3A, once the lock button 14 and/or 24 is depressed, an OSD 130 appears on the screen to provide feedback to a user to let them know to enter the password or key combination to lock the remote control 12 and/or electronic device 100.

As long as the correct password or key combination is entered, the device locks. If the wrong password or key combination is entered a new message may be displayed indicating the wrong password has been entered and asking the user to try again.

FIG. 3B illustrates an on screen display for entering a lock code to unlock an electronic device 140. Unlocking the device preferably operates using the same method that is used for locking the device. However, in one embodiment the same password is used to lock and unlock the electronic device and/or remote control. In another embodiment, different passwords are used. In yet another embodiment, a password is only needed to unlock the electronic device and/or remote control. Once the lock button 14 and/or 24 is depressed, an OSD 140 may appear asking the user to enter the previously setup password or key combination to deactivate the lock. If the wrong combination is entered, the electronic device and/or remote control remains locked and a message may be displayed to try again.

In the preferred embodiment including an OSD, the user may enable the lock by simply pressing lock button 14 or 24 without entering any key combination. Once the lock is enabled, all the buttons on both the remote control 12 and the electronic device 22 are locked, except lock buttons 14 and 24. Consequently once the lock is enabled in the preferred embodiment, the only functional buttons are the lock buttons 14 and 24.

In the preferred embodiment including an OSD, a key combination is required to unlock the system 10. To unlock the system 10 in the preferred embodiment, lock button 14 or 24 is pressed to initiate the unlocking sequence. The system 10 then displays an OSD 140 to prompt the user to enter the key combination to disable the lock. If the correct key combination is entered, the system 10 is unlocked. If the incorrect key combination is entered, the system 10 remains locked and the user is prompted to try again.

While preferably a system with a display device designed to provide OSD's is powered on when the state of the lock is being changed, the locking feature may still be enabled or disabled without the OSD's being displayed, for example if the system is powered off. If the system is powered off, the lock feature may work exactly as described above except that the OSD prompting for a key combination would not be displayed. In another embodiment, initiating a change in the lock state may power on the electronic device 22 to display the OSD requesting a key combination.

Preferably some type of feedback such as a message saying wrong password is given when the password or key combination is entered incorrectly. However, no feedback is required and simply not enabling or disabling the lock may be the only result of an incorrect password or key combination. In addition, methods of feedback other than a OSD may be used. For example, in embodiments with backlit buttons, the buttons may blink or all turn on at the same time to indicate an incorrect entry. Remote controls 12 may also be made to vibrate for incorrect entries.

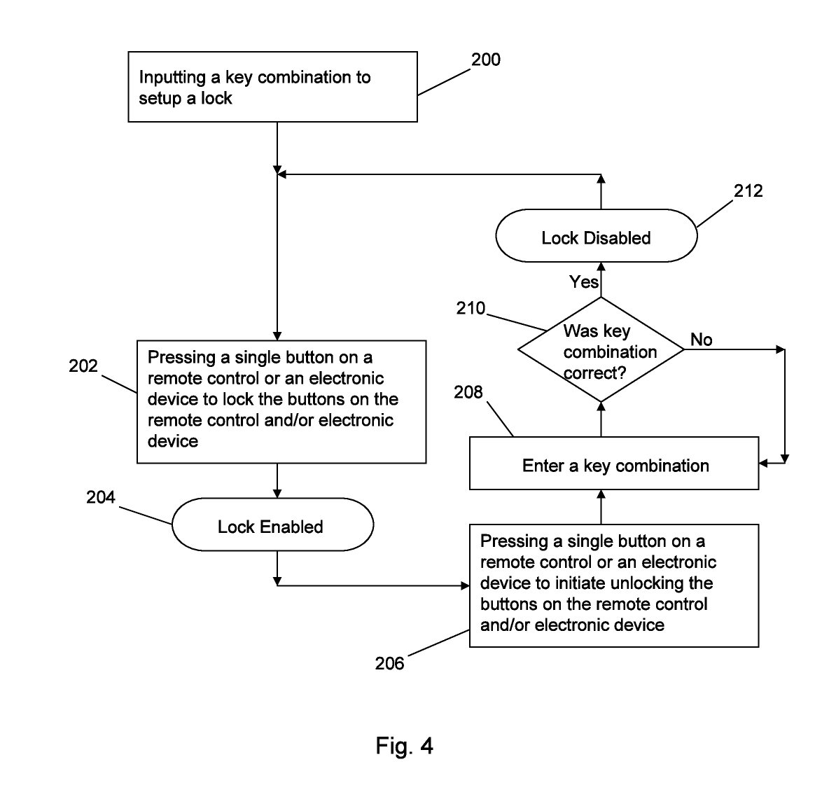

FIG. 4 illustrates one embodiment of a method of locking and unlocking an electronic device and/or remote control. In the embodiment of FIG. 4, the system is setup by first entering a key combination 200 to act as a password to unlock the electronic device and/or remote control. Once the lock feature is setup it may be activated by pressing a single button on the remote control and/or the electronic device 202. This allows the electronic device and/or remote control to be locked from any place or during any phase or state of operation of the electronic device by pressing only a single button 202.

After the single button is pressed the system enters the lock enabled state 204 and all the buttons on the remote control and the electronic device are disabled except the lock buttons. To exit the lock enabled state 204, either the single lock button on the remote control or the single lock button on the electronic device may be pressed 206. After pressing the lock button to remove the remote control and the electronic device from the lock enabled state a key combination may be entered 208.

The key combination entered in 208 is then verified against the key combination entered in step 200 to verify the key combination is correct 210. If the key combination is correct, the system enters the lock disabled state 212 and all the buttons on both the remote control and the electronic device resume their full functionality.

If the key combination entered in 208 does not match the key combination entered in 200, than the key combination must be reentered 208 and the system remains in the lock enabled state.

Although the embodiments have been described with reference to preferred configurations and specific examples, it will readily be appreciated by those skilled in the art that many modifications and adaptations of the methods, and systems for locking an electronic device and/or remote control described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. A remote control designed to operate an electronic device comprising:
a housing;
a plurality of buttons arranged on the housing; and
a single button designed to lock the plurality of buttons on the remote control.

2. The remote control of claim 1, wherein the single button is designed to lock the plurality of buttons on the remote control with a single push.

3. The remote control of claim 2, wherein the electronic device is a television.

4. The remote control of claim 1, wherein the single button is brightly colored.

5. The remote control of claim 1, wherein the single button is designed to unlock the plurality of buttons by simultaneous pushing the single button with at least one other button.

6. The remote control of claim 1, wherein a firmware of the remote control is designed to prevent a transmission of a signal by the remote control when the remote control is locked.

7. The remote control of claim 3, wherein the television is designed to display an on-screen-display when the plurality of buttons are locked and the single button is pushed.

8. A system for preventing unwanted control of an electronic device comprising:
a remote control, the remote control comprising:
a housing;
a plurality of buttons arranged on the housing; and
a single button designed to lock the plurality of buttons on the remote control.

9. The system of claim 8, further comprising a television.

10. The system of claim 9, wherein the television further comprises:
a television housing;
a plurality of television buttons arranged on the television housing; and
a single television button designed to lock the plurality of television buttons.

11. The system of claim 10, wherein the single button is further designed to lock the plurality of television buttons.

12. The system of claim 10, wherein the single television button is further designed to lock the plurality of buttons.

13. The system of claim 9, wherein the television is designed to bring up an on-screen-display for a password to unlock the system when the remote control and television are locked and either the single button or the single television button is pressed.

14. A method of preventing unwanted control of a television, the method comprising the steps of:
receiving a key combination designed to confirm an unlock signal;
receiving a first signal from a single button on a remote control or the television designed to enable a lock state; and
disabling the functionality of a plurality of buttons on the remote control and the television.

15. The method of claim 14, further comprising the step of receiving a second signal from the single button on the remote control or the television designed to disable the lock state.

16. The method of claim 15, further comprising the steps of receiving an unlock key combination; and
comparing the unlock key combination with the key combination designed to confirm an unlock signal.

17. The method of claim 16, further comprising the step of enabling the functionality of the plurality of buttons on the remote control and the television.

18. The method of claim 16, wherein the unlock key combination comprises depressing the single button on the remote control and simultaneously depressing at least one of the plurality of buttons on the remote control.

19. The method of claim 16, wherein entering the unlock key combination comprises depressing a sequence of the plurality of buttons on the remote control.

20. The method of claim 16, further comprising the step of displaying an on-screen-display on the television requesting the unlock key combination after the step of receiving a second signal from the single button on the remote control or the television designed to disable the lock state.
